(19) United States
(12) Patent Application Publication
(10) Pub. No.: US 2003/0005308 A1
(43) Pub. Date: Jan. 2, 2003

(54) Method and system for globally restricting client access to a secured web site

(76) Inventors: Paul L. Rathbun, West Bloomfield, MI (US); Michael Joseph Konopka, Livonia, MI (US); Matthew Todd Kromer, Fredericksburg, VA (US)

Correspondence Address: BROOKS & KUSHMAN P.C./FGTI, 1000 TOWN CENTER, 22ND FLOOR, SOUTHFIELD, MI, 48075, US

(21) Appl. No.: 09/681,737

(22) Filed: May 30, 2001

(51) Int. Cl. H04L 9/00

(52) U.S. Cl. 713/185

(57) ABSTRACT

A method and system are provided for restricting client access to a web site. A first web server receives a client login and, in response, allocates a cookie to the client containing an access credential having at least one client role-based attribute. A second web server hosts the secured web site, the web site having an associated security file containing at least one client role-based access privilege. In response to the client's HTTP request at the second server, the cookie is retrieved, decoded and the access credential is compared to the at least one client role-based access privilege. If the access credential has at least one role-based attribute in common with the at least one client role-based access privilege, the client is granted access to the site. Alternately, a site owner defines a token access credential attribute and security file privilege for hierarchal group access to the secured web site.

### BACKGROUND OF INVENTION

1. Field of the Invention

This invention relates generally to restricting access to a web site via single client logon and, more particularly, to a method and system for globally restricting client access to a secured web site based on role-based access credential attributes specific to the client.

2. Background Art

Today, many corporate entities rely extensively on web-based applications and informational resources to carry out their critical business activities. For example, a single manufacturing company may rely internally on web-based accounting, personnel, inventory and production applications. Externally, the company may purchase from and sell to hundreds of distributed suppliers communicating and executing purchase orders via the manufacturer's web-based purchasing and selling application.

To maintain an adequate level of integrity, business critical applications must be secured by competent access authorization validation solutions. Conventionally, each site developer creates his or her own solution to meet the security needs of the site or application owner. No standard security mechanism exists for globally defining access to web sites and web-based applications. Site or application owners that wish to restrict client access in any manner have to define, assign and manage unique passwords for every potential client user.

From the client users' perspective, password management is overwhelming as well. Most client users have to remember a unique password and login ID for each of the secured applications they utilize in their everyday business activities. As companies continue to streamline and secure business information on a web-based platform, the number of login IDs and passwords the average employee must remember increases.

To alleviate the site owners' burden of managing passwords and corresponding site access authorizations, site owners need a method and system for globally defining access among groups of clients having the application in common. For example, the administrator of a corporate purchasing application should be able to globally authorize all purchasing department employees or external suppliers to access his application. This global role-based authorization eliminates the need of defining, assigning and managing unique passwords for every potential client user.

To alleviate the client user's burden of remembering an overwhelming number of user IDs and corresponding passwords, the method and system should allow authorized clients to access the secured sites and applications utilizing a cookie-based access credential in lieu of a conventional user name and password login. Such a solution would require a client to authenticate him or herself via single logon to a security server transparent to the server hosting the secured application. Preferably, the security server allocates the corporate role-based access credentials to clients based on synchronized databases of pre-existing client passwords (e.g., Microsoft Outlook, Windows NT and LDAP-compliant directories, etc.).

### SUMMARY OF INVENTION

A system is provided for globally restricting client access to a secured web site. The system comprises a first and a second web server. The first web server is configured to receive a client login and return a cookie to the client containing an access credential wherein the access credential contains at least one role-based attribute specific to the client. The second web server hosts a secured web site having an associated security expression containing at least one role-based access privilege for the web site. The second web server is configured to receive the cookie containing the access credential in response to an HTTP request from the client and, if the access credential contains a role-based attribute in common with the security expression, grant the client access to the secured web site.

A method is provided for globally restricting client access to a secured web site. The method comprises receiving a client login at a first web server, returning a cookie to the client containing an access credential wherein the access credential contains at least one role-based attribute specific to the client, receiving the cookie from the client in response to an HTTP request at a second web server wherein the second web server hosts a secured web site having an associated security expression containing at least one role-based access privilege, and, if the access credential contains a role-based attribute in common with the security expression, granting the client access to the secured web site.

### BRIEF DESCRIPTION OF DRAWINGS

FIG. 1 is a block flow diagram illustrating a preferred method for carrying out the present invention;

FIG. 2 illustrates the environment in which the present invention operates;

FIG. 3 is a block flow diagram illustrating the secured server response to a client login; and

FIG. 4 is a tree diagram illustrating a hierarchal relationship among example token attributes in accord with the present invention.

### DETAILED DESCRIPTION

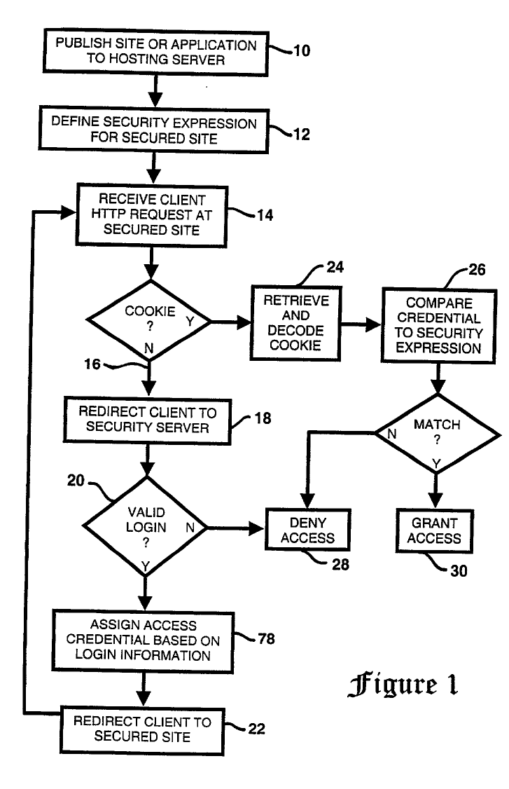

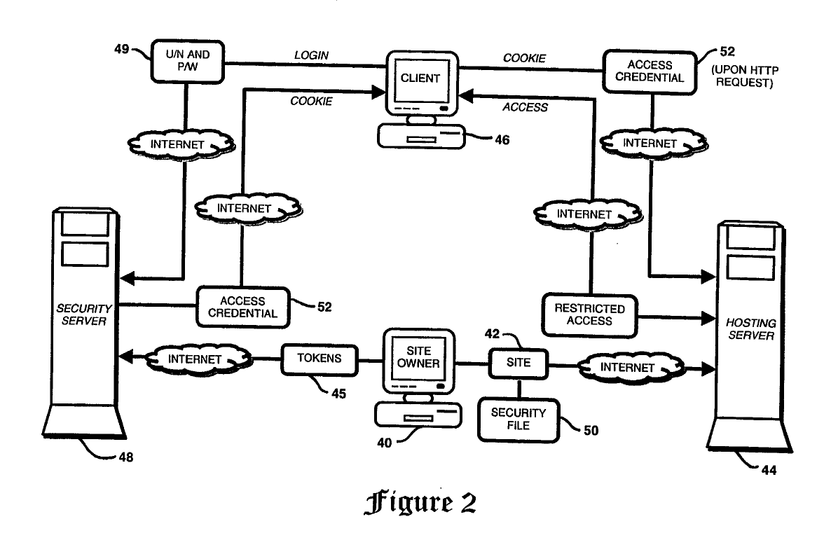

The present invention comprises a method and system for controlling access to a plurality of secured web sites or web-based applications via single client logon. FIG. 1 is an overview block flow diagram illustrating a preferred method for carrying out the invention. FIG. 2 illustrates a system for restricting access to a web site or application in accord with the present invention.

Referring to FIGS. 1 and 2, a site owner 40 publishes a web site 42 (or web-based application) to a hosting server 44 as described in block 10. To define which clients 46 are entitled to access the site, the site owner defines a security file 50 for the web site, as described in block 12. Security expression definition is discussed in more detail infra.

To access the secured site 42, a client 46 presents the hosting server 44 with an HTTP request as described in block 14. In response to the HTTP request, the hosting server 44 retrieves a cookie from the client containing an encoded access credential 52. If the client is accessing the secured site for the first time, the hosting computer will be unable to retrieve the necessary cookie as indicated by arrow 16 and will automatically redirect the client to a security server 48 as described in block 18.

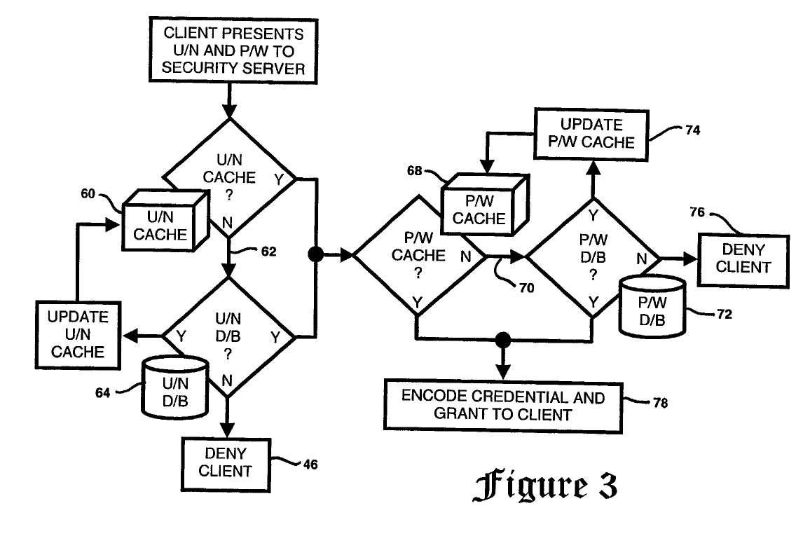

Upon redirect to the security server 48, the client 46 is presented with a conventional login request 49 comprising a user name and password as described in block 20. FIG. 3 is a block flow diagram illustrating the security server response to the client login. After receiving the client's user name and password, the security server queries a user name cache 60 for a user name matching the user name input by the client. If no match is found within the user name cache as indicated by arrow 62, the security server queries a user name database 64 for a user name matching the user name input by the client. If no match is found within the user name database, the client is denied access to the secured site 42 as described in block 65.

If a user name match is found within the user name database 64, the user name cache 60 is updated and the security server queries a password cache 68 for a password matching the password input by the client. If no match is found within the password cache as indicated by arrow 70, the security server queries a password database 72 for a password matching the password input by the client. If no match is found within the password database, the client is denied access to the secured site 42 as described in block 76. If a match is found within the password database 72, the password cache 68 is updated to include the client's password as described in block 74.

In accord with a preferred embodiment of the present invention, the password database 72 provides password synchronization among a plurality of password repositories (e.g., Microsoft Outlook, Microsoft Windows NT and lightweight directory access protocol-compliant directories (LDAP), etc.).

Referring again to FIGS. 1 and 2, clients having a valid user name and password are each granted a cookie containing a unique encoded access credential 52 as described in block 78. In accord with the preferred embodiment of the present invention, each access credential 52 comprises at least one attribute. Generally, access credential attributes can be divided into three categories: time-sensitive, corporate role-based, and token-based. Time sensitive access credential attributes comprise issue date and expiration date (e.g., ten hours from issue date). Corporate role-based access credential attributes comprise issuer, user identification, Internet protocol (IP) address, group name, department name, organization code, employee type, management role, organization name, common name, division abbreviation, building code, building city, building state, building country and authorization type. Token-based access credential attributes are discussed in more detail infra. A hash algorithm (e.g., RSA Security MD5) is used to provide integrity for the present invention. Authenticity for the present invention is provided using a public key algorithm (e.g., the RSA security RSA public key algorithm). The security server 48 contains the private key and the corresponding public key is contained within the hosting server 44.

After receiving a valid cookie containing an encoded access credential 52 from the security server 48, the client 46 is automatically redirected to the hosting server 44 as described in block 22.

In response to the redirected HTTP request at the secured site 42, the hosting server 44 retrieves the cookie containing the encoded access credential, distills the encoded access credential and decodes the access credential as described in block 24. Next, the decoded access credential is compared to the security file 50 having to determine whether the client is authorized to access the secured site as described in blocks 28 and 30.

For each site 42 hosted on the hosting server 44, the corresponding site owner 40 defines a security file containing various parameters and rules that define which users are authorized to access the secured site or application. Authorization is accomplished via a standard agent for NSAPI & ISAPI installed on the hosting server and granularity is to the directory level.

On the UNIX platform, the name of the security file is “.wslauth” On the Windows NT platform, the name of the security file is “auth.wsl”. The standard syntax for the security expression within the security file is: security=“security expression”. Table 1 contains security file syntax in accord with the present invention. Table 2 defines special characters for defining security expressions in accord with the present invention. Table 3 contains security files having example security file expressions.

TABLE 1
Security File Syntax

| Security File Syntax | Access Privileges |
|---|---|
| security = “off” or | all users (disables access |
| security = “none” | control) |
| security = “attribute:value” | users matching the attribute |
| | value |
| security = “attribute!value” | users not matching the |
| | attribute value |
| security = “$:token” | users possessing the token, |
| | discussed infra |

TABLE 2
Special Characters

| Character | Name | Meaning |
|---|---|---|
| \| | pipe | or |
| , | comma | and |
| ! | exclamation | not equal |
| : | colon | equal |
| * | asterisk | wildcard matches 0 |
| | | or more characters |
| ? | question | wildcard matches |
| | | exactly one |
| | | character |
| () | parenthesis | for grouping |
| | | conditionals |

TABLE 3
Security Files with Example Security Expressions

| Security File | Access Privileges |
|---|---|
| security = “empcode:F\|empc | All users having an F, A or J |
| ode:A\|empcode:J” | “employee code” access |
| | credential attribute |
| security = “user:prathbun\| | P. Rathbun and M. Kromer, as |
| user:mkromer” | identified by the user attribute |
| | within their respective “user” |
| | access credential attributes |
| security = “$:dearborn.wsl | All users that have the |
| .example” | dearborn.wsl.example “token” |
| | access credential attribute |
| security = “$:dearborn.wsl | All users that have the |
| .example\|user:prathbun” | dearborn.wsl.exemple “token” |
| | access credential attribute or |
| | P. Rathbun, as identified by his |
| | “user” access credential |
| | attribute |
| security = “mmrole:Y” | All users that possess the |
| | “management role” access |
| | credential attribute |

Unlike role-based access credential attributes (e.g., group name, department name, organization code, etc.), the “token” access credential attribute 45 allows a site owner 40 to locally allocate site access to particular users/clients 46 or groups of users/clients as indicated by arrow 47.

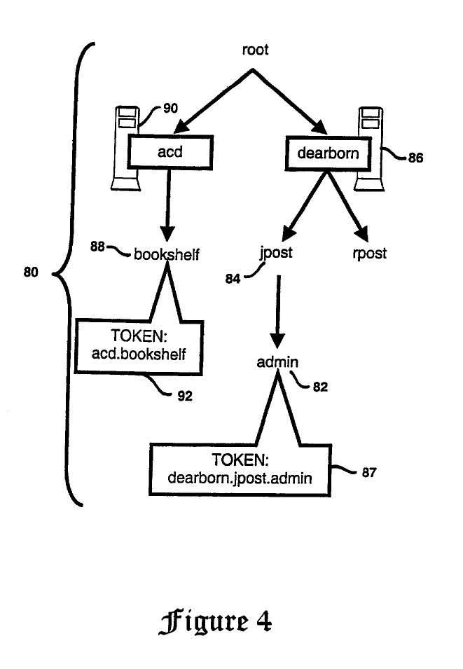

In accord with a preferred embodiment of the present invention, tokens are defined in a compounded format following an inverted group relationship. FIG. 4 illustrates an example hierarchal relationship 80 between tokens. According to the example, a user 80 with “admin” permission for the “jpost” application 84 on the “dearborn” server 86 is allocated a “dearborn.jpost.admin” token 87. Similarly, a user with access to the “bookshelf” application 88 on the “acd”server 90 is allocated an “acd.bookshelf” token 92.

Special tokens called token-administrating tokens allow a site owner 40 to allocate tokens having access permission re-granting capability. Token-administrating tokens have a “/create” or “/grant” suffix. The “/create” context allows a user in possession of the token to create a new administrator, or to generate a new token having the same prefix as the token-administrating token. The “/grant” context allows a user in possession of the token to grant a token containing identical access privileges to another user.

Table 4 contains a variety of token users each in possession of a unique token-administrating token.

TABLE 4
Token-Administrating Tokens

| Token User | Token Syntax | Explanation |
|---|---|---|
| Web Site | *./create | Can create any new |
| Administrator | | token for another |
| | | user that ends |
| | | with a “.”, a |
| | | “./create” or a |
| | | “./grant”. |
| Application | application.*.crea | Can create any new |
| Administrator | te | token for another |
| | | user that begins |
| | | with |
| | | “application.” and |
| | | ends with a “.”, a |
| | | “./create” or a |
| | | “./grant”. |
| Application | application.user./ | Can grant |
| Administrator | grant | “application.user” |
| | | permission to any |
| | | user. |

Notably, a plurality of sites or applications 42, each having a unique site owner 40 and corresponding security file 50 may be hosted on the hosting server 44. In an alternate embodiment, a plurality of hosting servers 44 each host at least one Web site or application 42 having a unique site owner 40 and corresponding security file 50.

While the best mode for carrying out the invention has been described in detail, those familiar with the art to which this invention relates will recognize various alternative designs and embodiments for practicing the invention as defined by the following claims.

1. A system for globally restricting client access to a secured web site comprising:
a first web server configured to:
receive a client login; and
return a cookie to the client containing an access credential wherein the access credential contains at least one role-based attribute specific to the client; and
a second web server hosting a secured web site having an associated security expression wherein the security expression contains at least one role-based access privilege for the web site, the second web server configured to:
receive the cookie containing the access credential in response to an HTTP request from the client; and
if the access credential contains a role-based attribute in common with the security expression, grant the client access to the secured web site.

2. The system of claim 1 wherein the access credential and security expression additionally contain a token attribute for locally defined access to the secured web site.

3. The system of claim 2 wherein the token attribute contains permission re-granting capability.

4. The system of claim 1 wherein the access credential is digitally signed.

5. The system of claim 1 wherein role based attributes are assigned to the client based on the client's login password.

6. The system of claim 5 wherein the first web server is additionally configured to synchronize client passwords among more than one password repository.

7. The system of claim 1 wherein the web site contains a web-based application.

8. The system of claim 1 wherein the access credential expires after a predefined period of time.

9. The system of claim 1 wherein the access credential is encoded.

10. A method for globally restricting client access to a secured web site comprising:
receiving a client login at a first web server;
returning a cookie to the client containing an access credential wherein the access credential contains at least one role-based attribute specific to the client;
receiving the cookie containing the access credential from the client in response to an HTTP request at a second web server wherein the second web server hosts a secured web site having an associated security expression containing at least one role-based access privilege; and
if the access credential contains a role-based attribute in common with the security expression, granting the client access to the secured web site.

11. The method of claim 10 wherein the access credential and security expression additionally contain a token attribute for locally defined access to the secured web site.

12. The method of claim 11 wherein the token attribute contains permission re-granting capability.

13. The method of claim 10 wherein the access credential is digitally signed.

14. The method of claim 10 wherein role based attributes are assigned to the client based on the client's login password.

15. The system of claim 14 wherein the first web server is configured to synchronize client passwords among more than one password repository.

16. The system of claim 10 wherein the web site contains a web-based application.

17. The system of claim 10 wherein the access credential expires after a predefined period of time.

18. The system of claim 10 wherein the access credential is encoded.
